(19) United States
(12) Patent Application Publication
(10) Pub. No.: US 2014/0307808 A1
(43) Pub. Date: Oct. 16, 2014

(54) PROTECTION AGAINST PACKET LOSS DURING TRANSMITTING VIDEO INFORMATION

(71) Applicants: Boris KUDRYASHOV, Saint-Petersburg (RU); INTEL Corporation, Santa Clara, CA (US)

(72) Inventors: Boris Kudryashov, Saint-Petersburg (RU); Sergey Petrov, Saint-Petersburg (RU); Eugeniy Ovsyannikov, Saint-Petersburg (RU)

(21) Appl. No.: 13/977,032

(22) PCT Filed: Dec. 14, 2012
(86) PCT No.: PCT/RU2012/001071

§ 371 Date: Jun. 28, 2013

(51) Int. Cl. H04N 19/89; H04N 19/91; H04N 19/65

(52) U.S. Cl. CPC H04N 19/00933; H04N 19/00854; H04N 19/00951
USPC 375/240.27; 375/240.26

(57) ABSTRACT

Methods and systems may provide for using an adaptive entropy encoder to generate a compressed video signal based on an input video signal. Additionally, a compressed state signal can he generated based on the internal state of the adaptive entropy encoder. In one example, the compressed state signal is selectively incorporated into a data stream containing the compressed video signal.

### BACKGROUND

Video codecs may be used to compress video signals in a lossy and/or lossless fashion prior to transmission of the video signals across a communication channel, wherein compression may conserve channel bandwidth as well as reduce transmission power consumption. For example, a parametric encoder might represent each macroblock of a current frame as a set of parameters based on a control signal to obtain lossy compression/encoding of the video signal, whereas an adaptive entropy encoder may conduct lossless encoding of the output of the parametric encoder. Additionally, the control signal, the output of the parametric encoder and the output of the adaptive entropy encoder may be combined into a data stream for transmission over the communication channel, wherein a decoder at the receiving end of the channel may perform the inverse operation to generate synthesized video data. Typical communication channels, however, may be subject to packet losses, which may in turn prevent conventional decoders from reconstructing frames received after one or more packets have been lost. More particularly, variable-rate entropy encoding may involve the synchronization of codewords between packets, wherein lost packets can eliminate the ability to conduct the codeword synchronization.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a system to protect against packet loss in a video signal according to an embodiment;

FIG. 2A is a flowchart of an example of a method of protecting against packet loss in a transmitted video signal according to an embodiment;

FIG. 2B is a flowchart of an example of a method of protecting against packet loss in a received video signal according to an embodiment;

FIG. 3 is a block diagram of an example of a system having a navigation controller according to an embodiment; and

FIG. 4 is a block diagram of an example of a system having a small form factor according to an embodiment.

### DETAILED DESCRIPTION

Embodiments may include an encoder apparatus having an encoder architecture to use an adaptive entropy encoder to generate a compressed video signal based on an input video signal. The apparatus can also have a side information encoder to generate a compressed state signal based on an internal state of the adaptive entropy encoder.

Embodiments may also include a computer readable storage medium having a set of instructions which, if executed by a processor, cause a computer to use an adaptive entropy encoder to generate a compressed video signal based on an input video signal. The instructions, if executed, may also cause a computer to generate a compressed state signal based on an internal state of the adaptive entropy encoder.

Additionally, embodiments can include a decoder apparatus having a decoder architecture to detect a packet loss in a channel associated with a data stream. The decoder apparatus may also have a switch module to determine whether the data stream includes a compressed state signal or a repeat of a compressed video signal in response to the packet loss.

In addition, embodiments may include a computer readable storage medium having a set of instructions which, if executed by a processor, cause a computer to detect a packet loss in a channel associated with a data stream. The instructions, if executed, may also cause a computer to determine whether the data stream includes a compressed state signal or a repeat of a compressed video signal in response to the packet loss.

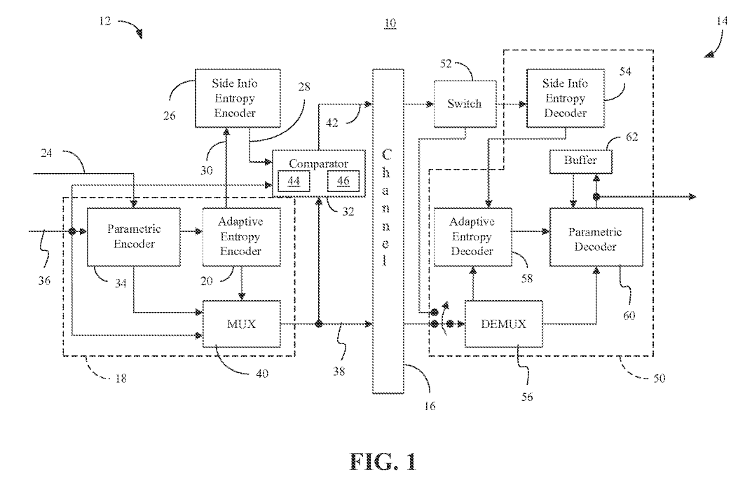

Turning now to FIG. 1, a system 10 is shown in which an encoder apparatus 12 generally transmits a video data stream to a decoder apparatus 14 over a communication channel 16. The communication channel 16 might have bandwidth limitations, noise, etc., that leads to packet loss in the transmitted data stream. As will be discussed in greater detail, the illustrated system 10 selectively uses side information 42 to supplement the video data stream to reduce the likelihood of packet losses leading to an inability of the decoder apparatus 14 from being able to reconstruct frames received after one or more packets have been lost.

More particularly, the illustrated encoder apparatus 12 includes an encoder architecture 18 having a parametric encoder 34 to represent each macroblock of an input video signal 24 as a set of parameters based on a control signal 36 (e.g., indicating bit rate, frame type, amount of slices, quality level and/or other channel feedback information, etc.). The encoder architecture 18 may also use an adaptive entropy encoder 20 to generate a compressed video signal based on the parameters of the input video signal 24, wherein a side information encoder 26 may in turn generate a compressed state signal 28 based on an internal state 30 of the adaptive entropy encoder 20. The control signal 36, the output of the parametric encoder 34 and the output of the adaptive entropy encoder 20 may be combined into a compressed video signal 38 by a multiplexer 40, wherein the compressed video signal 38 may be combined with the side information 42 into a data stream to be transmitted on the channel 16.

Of particular note is that the internal state 30 of the adaptive entropy encoder may generally indicate how much of the video signal 24 has been processed by the adaptive entropy encoder 20. In this regard, video frames may be partitioned into slices, which can further be partitioned into macroblocks for more efficient processing. Thus, if the internal state 30 corresponds to a macroblock in the middle of a particular slice, then if a packet from the first half of the slice is lost, the second half of the slice in question may be reconstructed by the decoder apparatus 14 from the internal state 30, wherein the side information 42 may include the internal state 30. The side information 42 may alternatively include a repeat of the compressed video signal 38, as will be discussed in greater detail.

The internal state 30, which can include context indices, most probable bit flags, context adaptive binary arithmetic coding (CABAC) states, and so forth, may therefore be determined at intermediate points within a slice of a frame. While increasing the number of intermediate points may generally reduce the impact of lost packets on the decoder apparatus 14 and enhance performance, substantially increasing the number of intermediate points may potentially have a negative impact on bit rate. Compared to traditional encoding approaches, however, such as CABAC without the use of error resilience tools, context adaptive variable length coding (CAVLC) with the use of error resilience tools (e.g., flexible macroblock ordering/FMO), and so forth, determining the internal state 30 at, for example, four intermediate points per slice would not have a significant impact on bit rate. Indeed, for video having mostly static scenes, the size of the side information 42 is likely to be comparable to the transmitted video itself, and may have a negligible impact on the bit rate.

Moreover, an intelligent determination as to whether/when to incorporate the side information 42 into the data stream containing the compressed video signal 38 may also be made. For example, the illustrated encoder apparatus 12 also includes a comparator 32 to selectively incorporate the side information 42 into the data stream. Thus, the comparator 32 might incorporate the side information 42 into the data stream if the input video signal 24 corresponds to an inter frame (I-frame), a first frame in a group of packets, or other type of reference frame, since the loss of such data may lead to large error propagation. Moreover, the comparator 32 may incorporate the side information 42 into the data stream if a packet loss of the channel 16 exceeds a particular threshold (e.g., greater than x lost bits per second). The type of frame in the video signal 24 as well as the packet loss state of the channel 16 may be determined, for example, based on the control signal 36.

The illustrated comparator 32 may also use the control signal 36 to compare the compressed state signal 28 to a repeat of the compressed video signal 38. In this regard, for some video fragments, the size of the compressed state signal 28 that describes the internal state 30 of the adaptive entropy encoder 20 may be comparable with the size of the compressed video fragment itself. Thus, in certain cases, the compressed video fragment can be repeated as the side information 42, in one example, the control signal 36 includes weight information that facilitates an appropriate comparison between the sizes of the compressed state signal 28 and the repeat of the compressed video signal 38.

The comparator 32 may include first logic 44 to incorporate the compressed state signal 28 into the data stream if the size of the compressed video signal 38 exceeds the size of the compressed state signal 28. If the size of the compressed video signal 38 does not exceed the size of the compressed state signal 28, however, second logic 46 may incorporate the repeat of the compressed video signal 38 into the data stream.

The illustrated decoder apparatus 14 includes a decoder architecture 50 to detect a packet loss in the channel 16 associated with the video bit stream and a switch module 52 to determine whether the data stream includes a compressed state signal or a repeat of the compressed video signal 38 in response to the packet loss. As already noted, the compressed state signal may indicate an internal slate of the adaptive entropy encoder 20. More particularly, the switch module 52 may pass the compressed state signal to a side information decoder 54 in the decoder architecture 50 if the data stream includes the compressed state signal. If the data stream includes the repeat of the compressed video signal, on the other hand, the illustrated switch module 52 passes the repeat of the compressed video signal to a demultiplexer (DEMUX) 56 in the decoder architecture 50, wherein the demultiplexer 56 may parse the repeat of the compressed video signal for further processing by an adaptive entropy decoder 58 and a parametric decoder 60.

The side information decoder 54 may decode the compressed state signal and provide the result to the adaptive entropy decoder 58. Thus, the adaptive entropy decoder 58 may process either the input from the side information decoder 54 or the input from the demultiplexer 56, depending upon the circumstances. Additionally, the parametric decoder 60 may process the input from the adaptive entropy decoder 58, which may constitute either decoded side information or the decoded video signal, and the input from the demultiplexer 56, which contains the parameter information generated by the parametric encoder 34. If a packet loss condition is present and the input from the adaptive entropy decoder 58 includes decoded side information, the illustrated parametric decoder 60 of the decoder architecture 50 generates one or more synthesized frames based on one or more of the compressed state signal and the repeat of the compressed video signal. In this regard, the parametric decoder 60 may use a buffer 62 to store the synthesized frames.

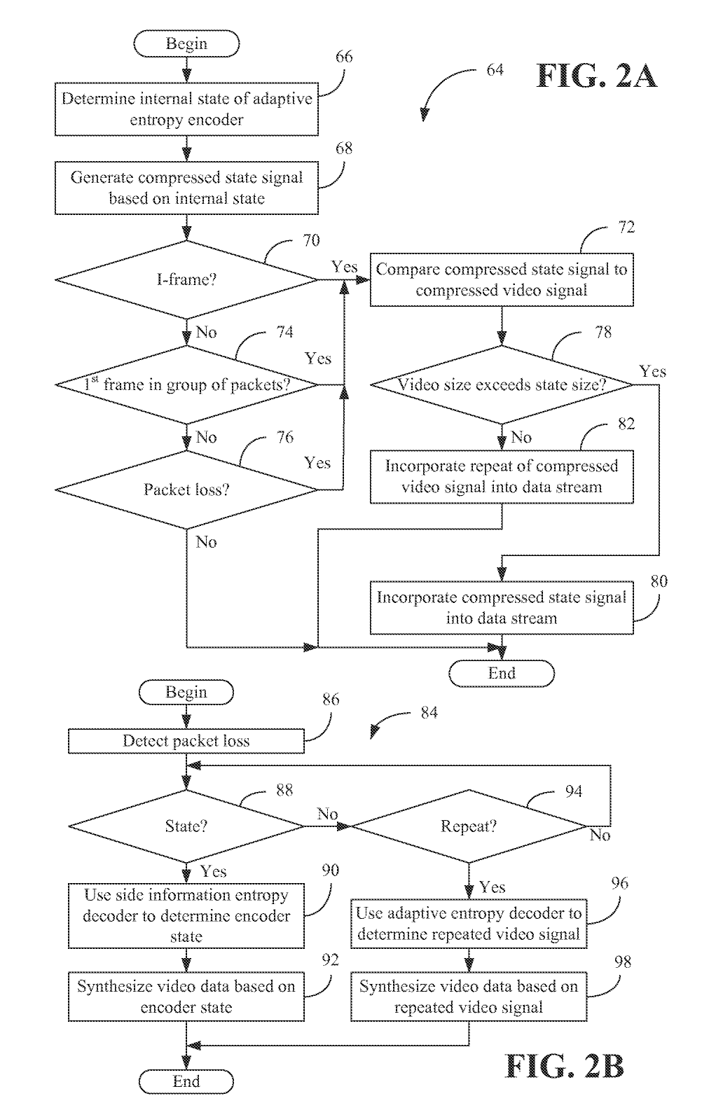

FIG. 2A shows a method 64 of protecting against packet loss in a transmitted video signal. The method 64 may be implemented in executable software as a set of logic instructions stored in a machine- or computer-readable storage medium of a memory such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 64 may be written in any combination of one or more programming languages, including an object oriented programming language such as Java, Smalltalk, C++ or the like and conventional procedural programming languages, such as the “C” programming language or similar programming languages.

Illustrated processing block 66 determines an internal state of an adaptive entropy encoder, wherein a compressed state signal may be generated based on the internal state at block 68. Additionally, a determination may be made at block 70 as to whether a current slice of an input video signal corresponds to an I-frame, which may be used by the decoder as a reference frame to reconstruct other frames. If so, the compressed state signal is compared to a compressed version of the input video signal at illustrated block 72, wherein the comparison may be weighted. If an I-frame is not detected at block 70, illustrated block 74 determines whether the current slice of the input video signal corresponds to the first frame in a group of packets, wherein such a frame may also be used by the decoder to reconstruct other frames/packets in the group and the comparison at block 72 is conducted if such a condition is detected.

In addition, a determination may be made at block 76 as to whether the communication channel associated with the video signal has a packet loss that exceeds a certain threshold. If so, the comparison 72 may also be conducted. Control signal information such as the control signal 36 (FIG. 1) may be received and used to make the determinations at blocks 70, 74 and 76, as already discussed. Such a control signal may also be received and used (e.g., via weighting) to conduct the comparison at block 72. Block 78 may determine whether the size of the compressed video signal exceeds the size of the compressed state signal. If so, the compressed state signal may be incorporated into the data stream containing the compressed video signal at block 80. Otherwise, illustrated block 82 incorporates a repeat of the compressed video signal into the data stream.

FIG. 2B shows a method 84 of protecting against packet loss in a received video signal. The method 84 may be implemented in executable software as a set of logic instructions stored in a machine- or computer-readable storage medium of a memory such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 86 detects a packet loss in a channel associated with a video data stream, wherein a determination may be made at block 88 as to whether the data stream includes side information having a compressed state signal. If so, the compressed state signal may be passed to a side information entropy decoder, which may use the compressed state signal at block 90 to determine an internal state of an adaptive entropy encoder that compressed the video content in the data stream. Additionally, one or more synthesized frames may be generated at block 92 based on the internal state of the adaptive entropy encoder.

If a compressed state signal is not detected at block 88, illustrated block 94 determines whether the data stream includes side information having a repeat of the compressed video signal. If so, the repeat of the compressed video signal may be passed to an adaptive entropy decoder, which may use the repeat at block 96 to determine a repeated video signal. One or more synthesized frames may be generated at block 98 based on the repeated video signal.

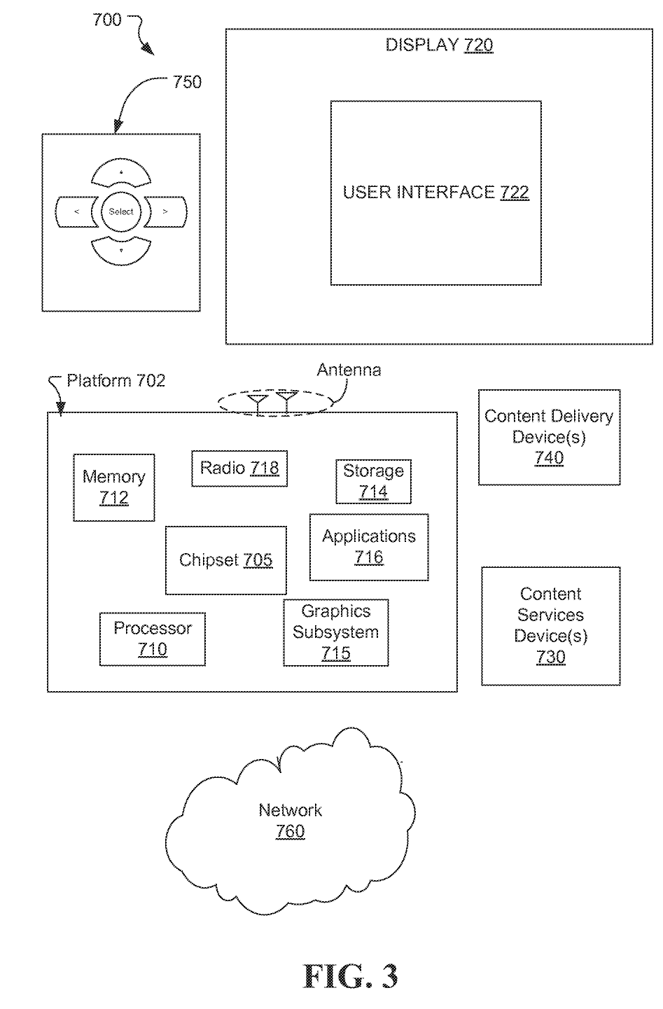

FIG. 3 illustrates an embodiment of a system 700 that may be used to encode and/or decode a video signal as described herein. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth. Thus, the system 700 may be used to display video bitstreams as described herein.

In embodiments, the system 700 comprises a platform 702 coupled to a display 720. Platform 702 may receive video bitstream content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. The graphics subsystem 715 may therefore include portions of the system 10 (FIG. 1), already discussed. An analog or digital interface may be used to communicatively couple graphics subsystem 715 and display 720. For example, the interface may be any of a High-Definition Multimedia. Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used As still another embodiment, the graphics and/or video functions may be implemented by a general purpose processor, including a multi-core processor. In a further embodiment, the functions may be implemented in a consumer electronics device.

The radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example, in embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for Si surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 3.

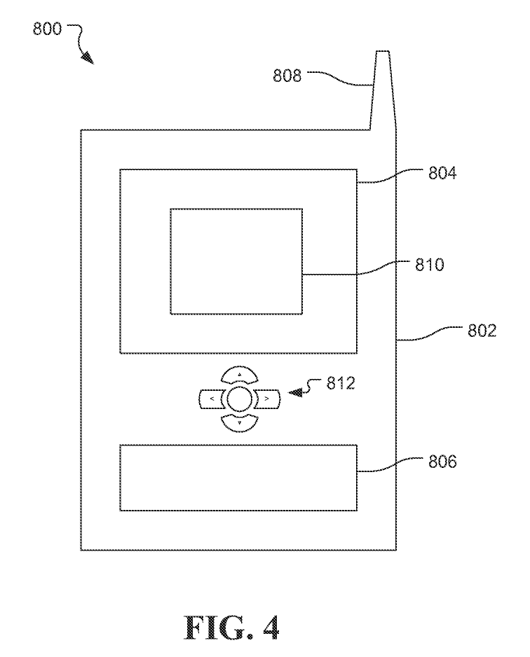

As described above, system 700 may be embodied in varying physical styles or form factors. FIG. 4 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG, 4, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Thus, techniques described herein may provide for state CABAC state saving in video streams such as, for example, H.264 video streams (e.g., Recommendation H.264, Advanced video coding for generic audiovisual services, Annex G, ITU-T, 01/2012). Additionally, video data reconstruction may be implemented in cases of lost packets, based on saving/transmitting intermediate states of the encoder. Moreover, side information may be selected for data reconstruction based on frame type, the size of the compressed frame, and the bit size if the compressed state information. Techniques may also provide for using channel quality information to determine whether to send side information.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gale array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1.-30. (canceled)

31. An encoder apparatus comprising:
an encoder architecture to use an adaptive entropy encoder to generate a compressed video signal based on an input video signal; and
a side information encoder to generate a compressed state signal based on an internal state of the adaptive entropy encoder.

32. The apparatus of claim 31, further including a comparator to selectively incorporate the compressed state signal into a data stream containing the compressed video signal.

33. The apparatus of claim 32, wherein the comparator is to incorporate side information into the data stream if the input video signal corresponds to one or more of an inter frame (I-frame) and a first frame in a group of packets, wherein the side information includes one of the compressed state signal and a repeat of the compressed video signal.

34. The apparatus of claim 32, wherein the comparator is to incorporate side information into the data stream if a packet loss of a channel associated with the data stream exceeds a threshold, wherein the side information includes one of the compressed state signal and a repeat of the compressed video signal.

35. The apparatus of claim 32, wherein the comparator is to receive a control signal and use the control signal to compare the compressed state signal to the compressed video signal.

36. The apparatus of claim 35, wherein the control signal is to include one or more of weight information and channel feedback information.

37. The apparatus of claim 35, wherein the comparator includes:
first logic to incorporate the compressed state signal into the data stream if a size of the compressed video signal exceeds a size of the compressed state signal, and
second logic to incorporate a repeat of the compressed video signal into the data stream if the size of the compressed video signal does not exceed the size of the compressed state signal.

38. The apparatus of claim 31, wherein the internal state of the adaptive entropy encoder is to include one or more of context indices, most probable bit flags and a context adaptive binary arithmetic coding (CABAC) state.

39. A computer readable storage medium comprising a set of instructions which, if executed by a processor, cause a computer to:
use an adaptive entropy encoder to generate a compressed video signal based on an input video signal; and
generate a compressed state signal based on an internal state of the adaptive entropy encoder.

40. The medium of claim 39, wherein the instructions, if executed, cause a computer to selectively incorporate the compressed state signal into a data stream containing the compressed video signal.

41. The medium of claim 40, wherein the instructions, if executed, cause a computer to incorporate side information into the data stream if the input video signal corresponds to one or more of an inter frame (I-frame) and a first frame in a group of packets, wherein the side information includes one of the compressed state signal and a repeat of the compressed video signal.

42. The medium of claim 40, wherein the instructions, if executed, cause a computer to incorporate side information into the data stream if a packet loss of a channel associated with the data stream exceeds a threshold, wherein the side information includes one of the compressed state signal and a repeat of the compressed video signal.

43. The medium of claim 40, wherein the instructions, if executed, cause a computer to:
receive a control signal; and
use the control signal to compare the compressed state signal to the compressed video signal.

44. The medium of claim 43, wherein the control signal is to include one or more of weight information and channel feedback information.

45. The medium of claim 43, wherein the instructions, if executed, cause a computer to:
incorporate the compressed state signal into the data stream if a size of the compressed video signal exceeds a size of the compressed state signal; and
incorporate a repeat of the compressed video signal into the data stream if the size of the compressed video signal does not exceed the size of the compressed state signal.

46. The medium of claim 39, wherein the internal state of the adaptive entropy encoder is to include one or more of context indices, most probable bit flags and a context adaptive binary arithmetic coding (CABAC) state.

47. A decoder apparatus comprising:
a decoder architecture to detect a packet loss in a channel associated with a data stream; and
a switch module to determine whether the data stream includes a compressed state signal or a repeat of a compressed video signal in response to the packet loss.

48. The apparatus of claim 47, wherein the compressed state signal is to indicate an internal state of an adaptive entropy encoder.

49. The apparatus of claim 47, further including a side information decoder, wherein the switch module is to pass the compressed state signal to the side information decoder if the data stream includes the compressed state signal.

50. The apparatus of claim 49, wherein the side information decoder is to decode the compressed state signal.

51. The apparatus of claim 47, wherein the decoder architecture includes an adaptive entropy decoder, and wherein the switch module is to pass the repeat of the compressed video signal to the adaptive entropy decoder if the data stream includes the repeat of the compressed video signal.

52. The apparatus of claim 47, wherein the decoder architecture is to generate one or more synthesized frames based on one or more of the compressed state signal and the repeat of the compressed video signal.

53. The apparatus of claim 52, further including a buffer to store the one or more synthesized frames.

54. A computer readable storage medium comprising a set of instructions which, if executed by a processor, cause a computer to:
detect a packet loss in a channel associated with a data stream; and
determine whether the data stream includes a compressed state signal or a repeat of a compressed video signal in response to the packet loss.

55. The medium of claim 54, wherein the compressed state signal is to indicate an internal state of an adaptive entropy encoder.

56. The medium of claim 54, wherein the instructions, if executed, cause a computer to pass the compressed state signal to a side information decoder if the data stream includes the compressed state signal.

57. The medium of claim 56, wherein the instructions, if executed, cause a computer to use the side information decoder to decode the compressed state signal.

58. The medium of claim 54, wherein the instructions, if executed, cause a computer to pass the repeat of the compressed video signal to an adaptive entropy decoder of a decoder architecture if the data stream includes the repeat of the compressed video signal.

59. The medium of claim 54, wherein the instructions, if executed, cause a computer to generate one or more synthesized frames based on one or more of the compressed state signal and the repeat of the compressed video signal.

60. The medium of claim 59, wherein the instructions, if executed, cause a computer to store the one or more synthesized frames to a buffer.
